(19) United States
(12) Patent Application Publication
(10) Pub. No.: US 2017/0156147 A1
(43) Pub. Date: Jun. 1, 2017

(54) RADIO COMMUNICATION SYSTEM, BASE STATION DEVICE, AND RADIO COMMUNICATION METHOD

(71) Applicant: FUJITSU LIMITED, Kawasaki-shi (JP)

(72) Inventors: Yasuo Tezuka, Yamato (JP); Kazunari Kobayashi, Yokohama (JP); Yuya Murakami, Yokohama (JP)

(73) Assignee: FUJITSU LIMITED, Kawasaki-shi (JP)

(21) Appl. No.: 15/284,803

(22) Filed: Oct. 4, 2016

(30) Foreign Application Priority Data
Nov. 30, 2015 (JP) 2015-233808

(51) Int. Cl. H04W 72/04; H04L 5/00

(52) U.S. Cl. CPC H04W 72/0453; H04L 5/0035

(57) ABSTRACT

A CA allocation determination unit determines allocation of each of first data to be sent by using a first frequency band and second data to be sent by using a second frequency band that are included in transmission data and notifies of information on the first data. An RB allocation determination unit allocates radio resources to the first data and the second data and notifies information on the radio resource allocated to the first data. A first data processing unit sends, by using the allocated radio resources, the first data and the second data to a radio terminal device. A second data management unit selects the first data from the transmission data by using the information on the first data. A second data processing unit sends, by using the radio resource allocated to the first data notified, the first data selected to the radio terminal device.

### CROSS-REFERENCE TO RELATED APPLICATION

This application is based upon and claims the benefit of priority of the prior Japanese Patent Application No. 2015-233808, filed on Nov. 30, 2015, the entire contents of which are incorporated herein by reference.

### FIELD

The embodiments discussed herein are directed to a radio communication system, a base station device, and a radio communication method.

### BACKGROUND

In recent years, with downsizing and high performance of radio terminal devices, mobile systems are becoming widely used. Furthermore, an improvement in diversification and convenience of application services provided in such mobile systems is required. To meet the request for such application services, a request to improve throughput of the mobile systems is increased.

Thus, as a technology used to respond to the request for mobile systems, Carrier Aggregation (CA) that simultaneously uses a plurality of frequency bands and Coordinated Multi-Point (CoMP), which will be described later, are proposed. Namely, by using CA and CoMP, the throughput of the mobile system can be improved.

Here, CoMP is a technology that improves, in the vicinity of cell boundaries, a reception environment of the radio wave by sending the same data in coordination with another cell. Specifically, a baseband processing unit in a base station device that accommodates a mobile terminal targeted for CoMP includes an interface for notifying a baseband processing unit in a base station device at the coordination transmission destination of the allocation result of resource blocks (RBs). Furthermore, the baseband processing unit in the base station device that accommodates the mobile terminal targeted for CoMP includes an interface for receiving and sending the data targeted for transmission from and to the baseband processing unit in the base station device at the coordination transmission destination. Both the baseband processing unit in the base station device that accommodates the mobile terminal targeted for CoMP and the baseband processing unit in the base station device at the coordination transmission destination share data and information related to the allocation of the resource blocks by using these interfaces.

Furthermore, to improve the throughput of the mobile systems, CA and CoMP are attempted to be combined. For example, a technology that appropriately sends and receives a feedback signal to and from a plurality of base stations and a single terminal is proposed.

Patent Document 1: Japanese Laid-open Patent Publication No. 2013-106133

Patent Document 2: Japanese Laid-open Patent Publication No. 2014-220678

However, with the conventional technology, when CA and CoMP are simply combined, if CoMP is performed during CA, inconsistency of transmission data may occur between the baseband processing unit at the coordination source and the baseband processing unit at the coordination transmission destination. Furthermore, in a method of transferring downlink data to the coordination destination after scheduling of downlink has been performed in a single base station, a delay occurs between the base stations by the time corresponding to the transfer time of downlink data.

### SUMMARY

According to an aspect of an embodiment, a radio communication system includes: a first base station device; a second base station device; and a radio terminal device, wherein the first base station device includes a data management unit that receives transmission data to be sent to the radio terminal device, an allocation determination unit that determines allocation of each of first data to be sent by using a first frequency band and second data to be sent by using a second frequency band that are included in the transmission data and that notifies the second base station device of information on the first data, a resource allocation unit that allocates a radio resource to each of the first data and the second data determined by the allocation determination unit and that notifies the second base station device of information on the radio resource allocated to the first data, and a first sending unit that sends, by using the radio resources allocated by the resource allocation unit, the first data and the second data to the radio terminal device, and the second base station device includes a receiving unit that receives, in coordination with the first base station device, transmission data that includes therein the first data to be sent to the radio terminal device, a data selecting unit that acquires the information on the first data notified by the allocation determination unit and that selects the first data from the transmission data based on the information on the first data, and a second sending unit that acquires the information that is related to the radio resource allocated to the first data and that is notified by the resource allocation unit and that sends the first data selected by the data selecting unit to the radio terminal device by using the radio resource allocated to the first data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating, in outline, a radio communication system;

FIG. 2 is a block diagram illustrating a base station device;

FIG. 3 is a block diagram illustrating a baseband processing unit according to a first embodiment;

FIG. 4 is a schematic diagram illustrating selecting data when CA and CoMP are performed in a radio communication system according to the first embodiment;

FIG. 5 is a sequence diagram illustrating communication control performed in the radio communication system according to the first embodiment by using CA and CoMP;

FIG. 6 is a block diagram illustrating a baseband processing unit according to a second embodiment;

FIG. 7 is a schematic diagram illustrating selecting data when CA and CoMP are performed in a radio communication system according to a second embodiment;

FIG. 8 is a sequence diagram illustrating communication control performed in a radio communication system according to the second embodiment by using CA and CoMP;

FIG. 9 is a block diagram illustrating the hardware configuration of the base station device; and

FIG. 10 is a block diagram illustrating the hardware configuration of a radio terminal device.

### DESCRIPTION OF EMBODIMENTS

Preferred embodiments of the present invention will be explained with reference to accompanying drawings. Furthermore, the radio communication system, the base station device, and the radio communication method disclosed in the present invention are not limited to the embodiments described below.

### First Embodiment

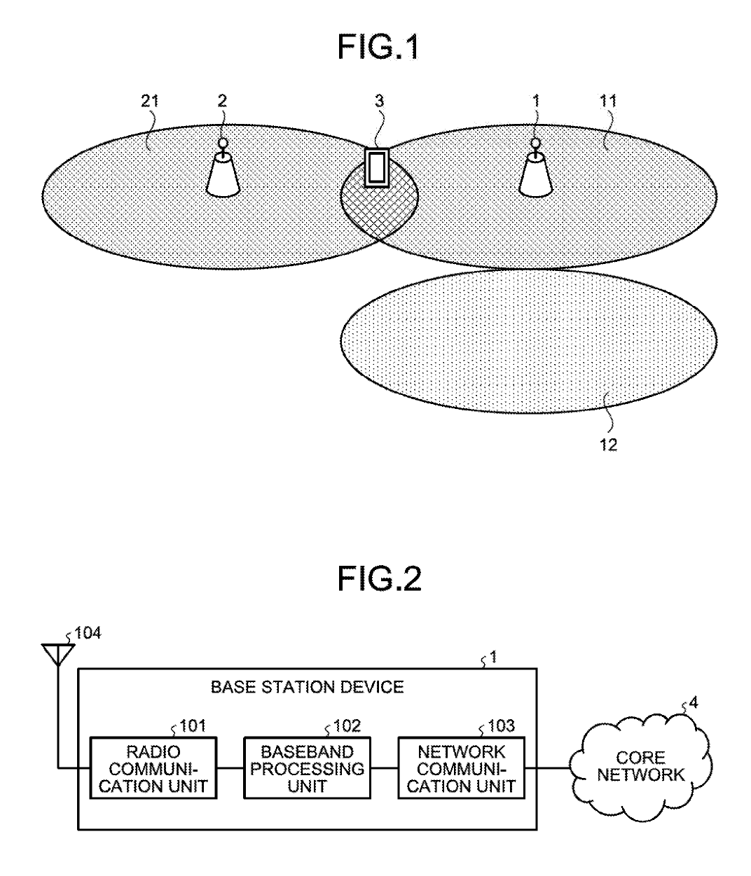

FIG. 1 is a schematic diagram illustrating, in outline, a radio communication system. A radio communication system according to the embodiment includes base station devices 1 and 2 and a radio terminal device 3. In the embodiment, the radio terminal device 3 performs communication by connecting to the base station device 1.

In the embodiment, the base station device 1 includes a cell 11 and a cell 12 that are used to perform CA. The cell 11 is a service area that is used by the base station device 1 to perform communication with the radio terminal device 3 by using a first frequency. The cell 12 is a service area that is used by the base station device 1 to perform communication with the radio terminal device 3 by using a second frequency. Then, the base station device 1 performs CA by using the cells 11 and 12.

Furthermore, the base station device 1 performs, by using the first frequency, CoMP on the radio terminal device 3 as the communication target. The base station device 1 performs CoMP in coordination with the base station device 2 as a master base station of communication that uses CoMP performed by using the first frequency. In a description below, the master base station of the communication that uses CoMP is sometimes referred to as a “coordination source base station”.

The base station device 2 includes a cell 21 that has an area overlapped with the cell 11. The cell 21 is a service area in which the base station device 2 performs communication with the radio terminal device 3 by using the first frequency. In communication that uses CoMP performed by using the first frequency, the base station device 2 sends data to the radio terminal device 3 in coordination with the base station device 1. In a description below, the base station device that performs communication that uses CoMP in coordination with the coordination source base station is sometimes referred to as a “coordination destination base station”.

FIG. 2 is a block diagram illustrating a base station device. In FIG. 2, the base station device 1 is illustrated as an example; however, the base station device 2 also has the same configuration.

The base station device 1 includes a radio communication unit 101, a baseband processing unit 102, a network communication unit 103, and an antenna 104. The radio communication unit 101 is connected to the antenna 104. The network communication unit 103 is connected to a core network 4. The base station device 1 performs communication with other base station devices including the base station device 2 via the core network 4.

The radio communication unit 101 is an interface for radio communication with the radio terminal device 3. The radio communication unit 101 receives, via the antenna 104, the radio signal sent from the radio terminal device 3. Then, the radio communication unit 101 outputs the received signal to the baseband processing unit 102. Furthermore, the radio communication unit 101 receives an input of the signal with the radio frequency from the baseband processing unit 102. Then, the radio communication unit 101 sends the radio signal to the radio terminal device 3 at the destination via the antenna 104.

The baseband processing unit 102 receives an input of the signal with the radio signal frequency from the radio communication unit 101. Then, the baseband processing unit 102 performs demodulation, changes the frequency of the received signal, and generates a baseband signal. Furthermore, the baseband processing unit 102 performs a decoding process on the generated baseband signal. Then, the baseband processing unit 102 outputs, to the network communication unit 103, the baseband signal subjected to the decoding process.

Furthermore, the baseband processing unit 102 receives an input of the baseband signal from the network communication unit 103. Then, the baseband processing unit 102 performs an encoding process on the received baseband signal. Furthermore, the baseband processing unit 102 modulates the baseband signal that has been subjected to the encoding process, changes the frequency, and generates a radio signal. Thereafter, the baseband processing unit 102 outputs the generated radio signal to the radio communication unit 101.

Furthermore, the baseband processing unit 102 controls communication that uses CA and CoMP. For example, when the baseband processing unit 102 performs communication that uses CA with respect to the radio terminal device 3, the baseband processing unit 102 allocates data to the cells 11 and 12. Furthermore, when the baseband processing unit 102 performs communication that uses CoMP with respect to the radio terminal device 3, the baseband processing unit 102 synchronizes, with a baseband processing unit 202 in the base station device 2, the transmission data and the resource blocks that are used for the communication. The function of the baseband processing unit 102 performed in communication that uses CA and CoMP will be described in detail later.

The network communication unit 103 is an interface that is used when the base station device 1 performs communication with the core network 4. The network communication unit 103 sends the data received from the baseband processing unit 102 to the core network 4. Furthermore, the network communication unit 103 outputs the data received from the core network 4 to the baseband processing unit 102.

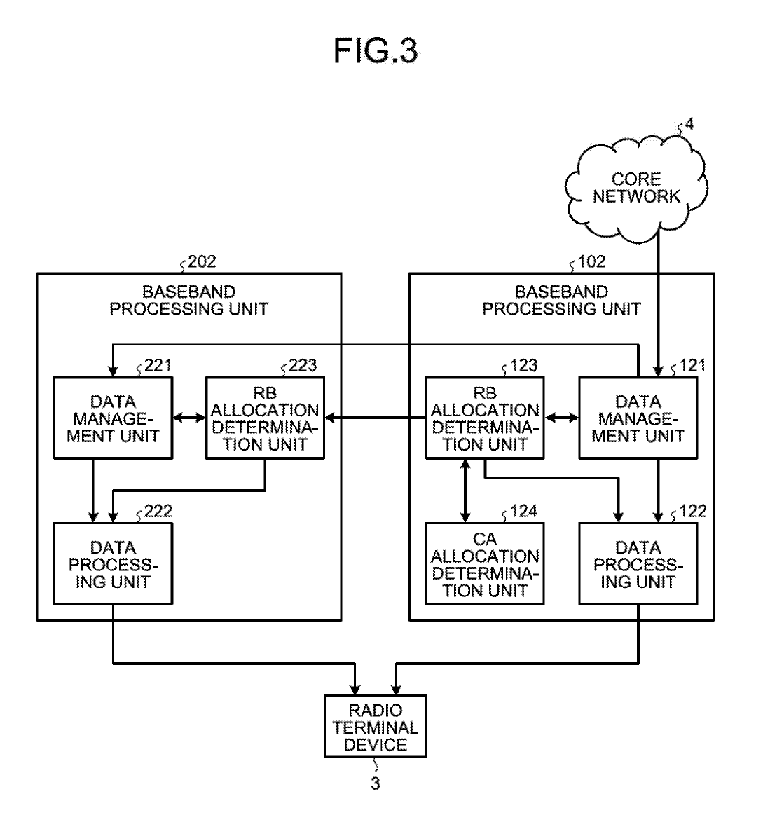

In the following, the baseband processing unit 102 in the base station device 1 and the baseband processing unit 202 in the base station device 2 will be described with reference to FIG. 3. FIG. 3 is a block diagram illustrating a baseband processing unit according to a first embodiment. Here, as described above, a description will be given with the assumption that the base station device 1 is a coordination source base station and the base station device 2 is a coordination destination base station. Here, in practice, the baseband processing unit 102 performs communication with the radio terminal device 3 via the radio communication unit 101 and performs communication with the base station device 2 via the network communication unit 103 and the core network 4. Furthermore, the same applied to the baseband processing unit 202. However, in a description below, for convenience of description, a description will be given such that the baseband processing unit 102 and the baseband processing unit 202 directly perform communication and, furthermore, the baseband processing units 102 and 202 directly send data to the radio terminal device 3.

The baseband processing unit 102 in the base station device 1 that is a coordination source base station includes a data management unit 121, a data processing unit 122, an RB allocation determination unit 123, and a CA allocation determination unit 124. Furthermore, the baseband processing unit 202 in the base station device 2 that is a coordination destination base station includes a data management unit 221, a data processing unit 222, and an RB allocation determination unit 223. Here, in practice, both the base station devices 1 and 2 can be operated as the coordination source base station and the coordination destination base station. Namely, in practice, the baseband processing unit 202 also has the function held by the baseband processing unit 102 illustrated in FIG. 3 and, in contrast, the baseband processing unit 102 also has the function held by the baseband processing unit 202.

The data management unit 121 receives the transmission data sent from the core network 4 to the radio terminal device 3. The transmission data includes a plurality of pieces of data in units to each of which a resource block is allocated. Then, the data management unit 121 adds a number to, for example, each of the pieces of the data included in the transmission data. The data management unit 121 holds the transmission data. Furthermore, the data management unit 121 sends, to the data management unit 221, the entirety of the received transmission data together with the numbers attached to the respective pieces of the data.

Then, the data management unit 121 obtains an amount of data of the retained transmission data. Then, the data management unit 121 notifies the RB allocation determination unit 123 of the obtained amount of data of the transmission data. At this time, the data management unit 121 notifies the RB allocation determination unit 123 of the numbers allocated to the respective pieces of the data.

Then, the data management unit 121 receives, from the RB allocation determination unit 123, a notification of information on the amount of data that has been allocated to the resource blocks. Then, the data management unit 121 outputs, to the data processing unit 122, the data associated with the amount of allocated data included in the transmission data.

The CA allocation determination unit 124 receives, from the RB allocation determination unit 123, a notification of the amount of data of the transmission data together with an allocation request for the data. Then, by using information on the radio resource that can be used in the cell 11 and the radio resource that can be used in the cell 12, the CA allocation determination unit 124 determines the allocation of data to be sent with the first frequency and the allocation of data to be sent with the second frequency. In a description below, allocation of data to be sent with the first frequency and allocation of data to be sent with the second frequency are referred to as “allocation of data in CA”.

Then, the CA allocation determination unit 124 notifies the RB allocation determination unit 123 of the allocation result of the determined data. For example, by notifying the numbers attached to the respective pieces of data allocated as the data to be sent with the first frequency and the numbers attached to the respective pieces of data allocated as the data to be sent with the second frequency, the CA allocation determination unit 124 sends a notification of the allocation result of data in CA. The CA allocation determination unit 124 corresponds to an example of an “allocation determination unit”. Then, the data allocated as the data to be sent with the first frequency corresponds to an example of “the first data” and the data allocated as the data to be sent with the second frequency corresponds to an example of “the second data”.

At this point, in the embodiment, the CA allocation determination unit 124 notifies the RB allocation determination unit 123 of the number allocated to the data; however, another information may also be used as long as information that can specify the first data. For example, the CA allocation determination unit 124 may also notify of the sequence number attached to the data by using the existing protocol, such as radio link control (RLC) or the like, as the allocation result of the data in CA.

The RB allocation determination unit 123 receives a notification of an amount of data of the transmission data from the data management unit 121. Then, the RB allocation determination unit 123 receives a notification of an amount of data of the transmission data together with the allocation request for the data from the CA allocation determination unit 124. Then, the RB allocation determination unit 123 acquires a notification of the allocation result of the data in CA from the CA allocation determination unit 124. Then, the RB allocation determination unit 123 determines, in accordance with the allocation of data in CA, the resource blocks that are defined in the radio resource and that are used to send the transmission data to the radio terminal device 3 by using the first frequency and the second frequency. Here, the frequency and the transmission timing are included in the radio resource that represents the resource blocks.

Then, the RB allocation determination unit 123 sends the allocation result of the data in CA to the RB allocation determination unit 223 in the base station device 2. Here, in the embodiment, all of the allocation results of the data in CA are sent; however, in practice, the RB allocation determination unit 123 may send the information on the data allocated to the first frequency to the RB allocation determination unit 223. For example, the RB allocation determination unit 123 sends, to the RB allocation determination unit 223, the numbers attached to the respective pieces of the data allocated as the data to be transmitted with the first frequency. Furthermore, the RB allocation determination unit 123 sends, to the RB allocation determination unit 223 in the base station device 2, the allocation result of the resource blocks that are used to send the transmission data.

Here, in the embodiment, the RB allocation determination unit 123 sends the data number to the RB allocation determination unit 223 as the allocation result of the data performed by using CA; however, the information may also be another information as long as the information that can recognize which of the pieces of the data is sent as the base station at the coordination destination of CoMP. For example, the RB allocation determination unit 123 may also send, to the RB allocation determination unit 223, the data itself that is sent by using the first frequency as the allocation information on the data performed by using CA.

Then, the RB allocation determination unit 123 notifies the data processing unit 122 of the allocation result of the resource blocks. Furthermore, the RB allocation determination unit 123 notifies the data management unit 121 of the information on an amount of the pieces of the data that have already been allocated to the resource blocks. The RB allocation determination unit 123 corresponds to an example of a “resource allocation unit”.

The data processing unit 122 receives a notification of the allocation result of the resource blocks from the RB allocation determination unit 123. Furthermore, the data processing unit 122 receives, from the data management unit 121, an input of pieces of data that are to be sent to the radio terminal device 3 and to which the respective resource blocks have been allocated. Then, the data processing unit 122 sends, by using the resource blocks allocated by the RB allocation determination unit 123, the data received from the data management unit 121 to the radio terminal device 3. Specifically, the data processing unit 122 sends the data to the radio terminal device 3 by using the CA using the first frequency and the second frequency. The data processing unit 122 corresponds to an example of a “first sending unit”.

In the following, the baseband processing unit 202 in the base station device 2 that is the coordination destination base station will be described.

The RB allocation determination unit 223 in the baseband processing unit 202 receives a notification of the allocation result of the data in CA from the RB allocation determination unit 123 in the baseband processing unit 102. Then, the RB allocation determination unit 223 notifies the data management unit 221 of the allocation result of the data in CA.

Furthermore, the RB allocation determination unit 223 receives the allocation result of the resource blocks from the RB allocation determination unit 123. Then, the RB allocation determination unit 223 notifies the data processing unit 222 of the allocation result of the resource blocks. Furthermore, the RB allocation determination unit 223 notifies the data management unit 221 of the amount of pieces of data to which the respective resource blocks have already been allocated.

The data management unit 221 receives the transmission data from the data management unit 121. Then, the baseband processing unit 202 holds the received transmission data.

Then, the data management unit 221 receives a notification of the allocation result of the data in CA from the RB allocation determination unit 223. Then, the data management unit 221 selects, from the stored transmission data by using the allocation information on the data in CA, the data to be sent by using the first frequency.

Then, the data management unit 221 receives a notification of the amount of the pieces of data to which the respective resource blocks have already been allocated from the RB allocation determination unit 223. Then, the data management unit 221 outputs, to the data processing unit 122, the data associated with the amount of the pieces of the allocated data from the stored transmission data. The data management unit 221 corresponds to an example of a “data selecting unit”.

The data processing unit 222 receives a notification of information on the allocation result of the resource blocks from the RB allocation determination unit 223. Furthermore, the data processing unit 222 receives, from the data management unit 221, an input of an amount of the pieces of the data that are to be sent to the radio terminal device 3 and to which the respective resource blocks have already been allocated. Then, the data processing unit 122 sends, by using the resource blocks allocated by the RB allocation determination unit 123, the data received from the data management unit 221 to the radio terminal device 3. Specifically, by using the same radio resource used in the first frequency, the data processing unit 222 sends, to the radio terminal device 3, the same data as that sent by the data processing unit 122 in the base station device 1 to the radio terminal device 3 by using the first frequency. The data processing unit 222 corresponds to an example of a “second sending unit”.

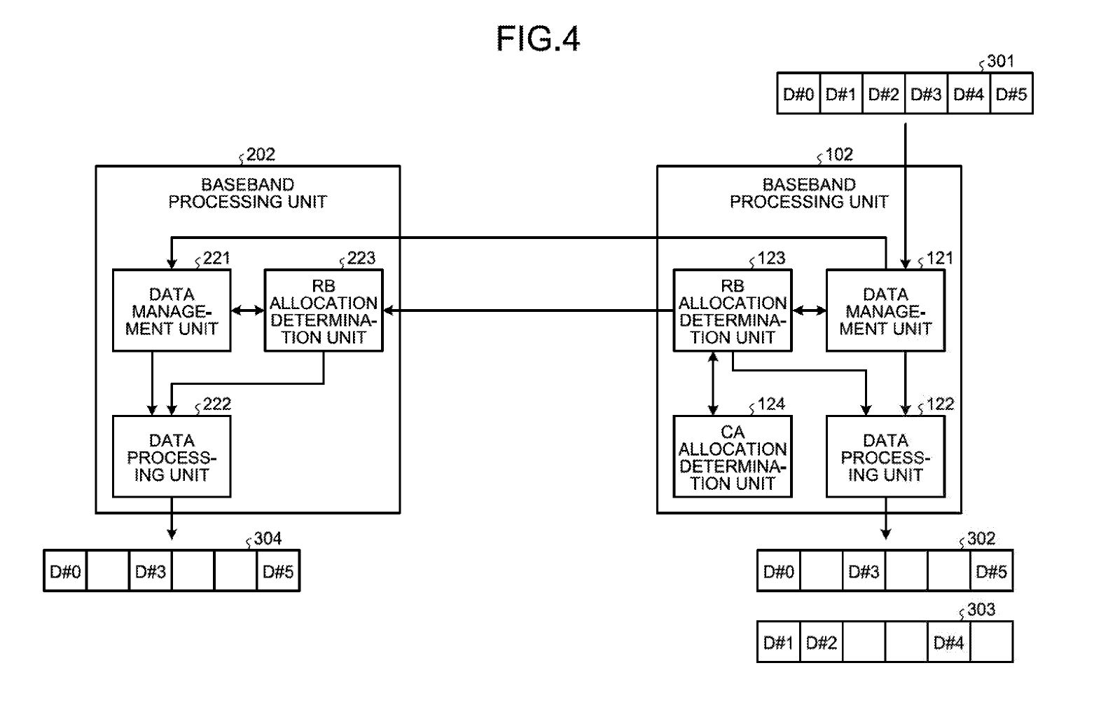

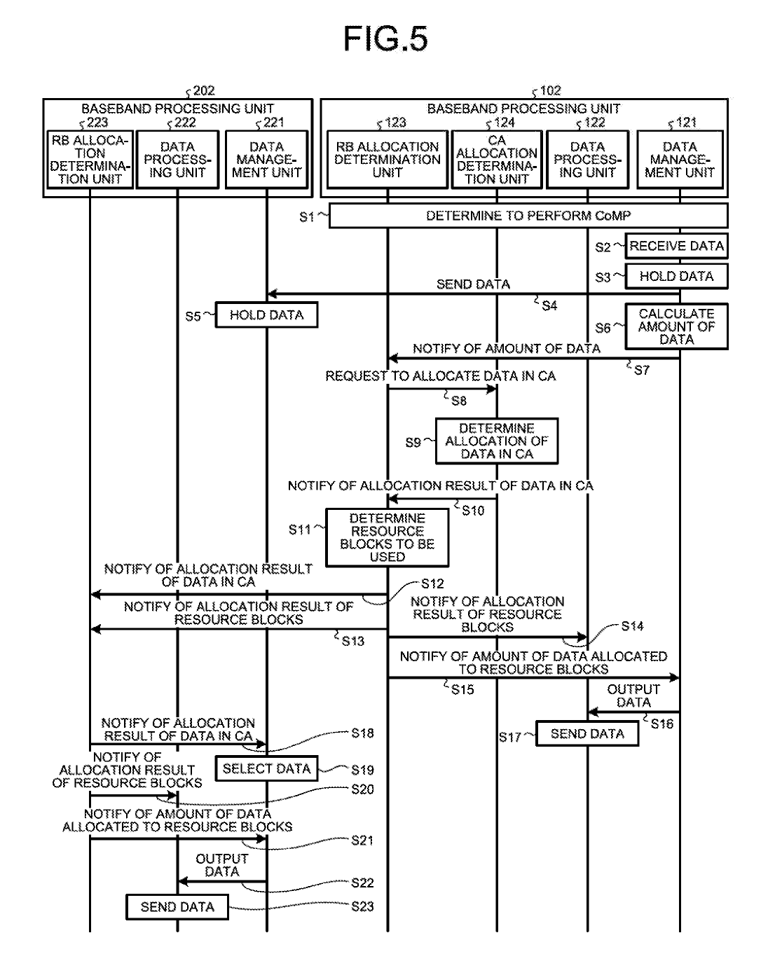

In the following, selecting data when CA and CoMP is performed in the radio communication system according to the embodiment will be described with reference to FIG. 4. FIG. 4 is a schematic diagram illustrating selecting data when CA and CoMP are performed in a radio communication system according to the first embodiment. Here, a description will be given of a case in which the transmission data that includes therein pieces of data #0 to #5 is sent from the core network 4 to the base station device 1. In FIG. 4, the pieces of the data #0 to #5 are represented by D #1 to #5, respectively.

The data management unit 121 in the baseband processing unit 102 receives, form the core network 4, transmission data 301 that includes therein the pieces of the data #0 to #5. The CA allocation determination unit 124 allocates the pieces of the data #0, #3, and #5 included in the transmission data 301 as the data to be sent with the first frequency. Furthermore, the CA allocation determination unit 124 allocates the pieces of the data #1, #2, and #4 included in the transmission data 301 as the data to be sent with the second frequency.

Then, the RB allocation determination unit 123 sends, to the RB allocation determination unit 223 in the baseband processing unit 202, the information indicating that the pieces of the data #0, #3, and #5 are allocated as the data to be sent with the first frequency.

Furthermore, the RB allocation determination unit 123 allocates the resource blocks to the pieces of the data #0, #3, and #5 as indicated by a resource allocation state 302. The resource allocation state 302 indicates that each of the blocks represents a single resource block used in the first frequency. For example, it is assumed that the resource blocks in the resource allocation state 302 illustrated in FIG. 4 are sequentially represented by RBs #0 to #6, respectively, from the right. In this case, in the resource allocation state 302 illustrated in FIG. 4, the data #0 (D #0) is allocated to a first resource block (RB #1). Furthermore, the data #3 (D #3) is allocated to a third resource block (RB #3). Furthermore, the data #5 (D #5) is allocated to a sixth resource block (D #6).

Furthermore, the RB allocation determination unit 123 allocates the resource blocks to the pieces of the data #1, #2, and #4 such as represented by a resource allocation state 303. For example, it is assumed that the resource blocks in the resource allocation state 303 illustrated in FIG. 4 are sequentially represented by RBs #0 to #6. In this case, in the resource allocation state 302 illustrated in FIG. 4, the data #0 (D #0) is allocated to the first resource block (RB #1). Furthermore, the data #2 (D #2) is allocated to a second resource block (RB #2). Furthermore, the data #4 (D #4) is allocated to a fifth resource block (D #5).

Then, the RB allocation determination unit 123 sends the allocation result of the resource blocks, i.e., the information that represents the resource allocation states 302 and 303, to the data processing unit 122. Furthermore, the RB allocation determination unit 123 sends the information that represents the resource allocation state 302 to the RB allocation determination unit 223. The information representing the resource allocation state 302 is information indicating, by using the subject information, a certain data is allocated to which of the resource blocks with which of the frequencies. For example, the information indicating the resource allocation state 302 is the identification information that indicates which one of the first frequency and the second frequency is allocated to each of the pieces of the data or that indicates the resource block number with that frequency.

The data processing unit 122 uses the received allocation result of the resource blocks and sends the pieces of the data #0, #3, and #5 to the radio terminal device 3 with the first frequency by using the resource blocks indicated by the resource allocation state 302. Furthermore, the data processing unit 122 uses the received allocation result of the resource block and sends the pieces of the data #1, #2, and #4 to the radio terminal device 3 with the second frequency by using the resource blocks indicated by the resource allocation state 303.

The RB allocation determination unit 223 in the baseband processing unit 202 sends, to the data management unit 221, the information indicating that the pieces of the data #0, #3, and #5 have been allocated as the data to be sent with the first frequency. Furthermore, the RB allocation determination unit 223 outputs the information indicating the resource allocation state 302 to the data processing unit 222.

The data management unit 221 receives the transmission data 301 including the pieces of the data #0 to #5 from the data management unit 121. The data management unit 221 uses the information indicating that the pieces of the data #0, #3, and #5 have been allocated as the data to be sent with the first frequency and selects, from the transmission data, the pieces of the data #0, #3, and #5 as the data that is to be sent, by using the first frequency, as the base station at the coordination destination for CoMP. Then, the data management unit 221 sends the pieces of the selected data #0, #3, and #5 to the data processing unit 222.

The data processing unit 222 receives an input of the pieces of the data #0, #3, and #5 from the data management unit 221. Then, the data processing unit 222 sends the pieces of the data #0, #3, and #5 to the radio terminal device 3 by using the same resource blocks as those indicated by the information that indicates the resource allocation state 302 received from the RB allocation determination unit 223. Namely, the data processing unit 222 sends the pieces of the data #0, #3, and #5 to the radio terminal device 3 by using the resource blocks indicated by a resource allocation state 304.

By performing the process described above, the data sent by the base station device 1 with the first frequency and the data sent by the base station device 2 with the first frequency are, as indicated by the resource allocation states 302 and 304, the same data and are sent by using the same resource blocks.

In the following, the flow of communication control performed in the radio communication system according to the embodiment by using the CA and the CoMP will be described with reference to FIG. 5. FIG. 5 is a sequence diagram illustrating communication control performed in the radio communication system according to the first embodiment by using the CA and the CoMP.

The baseband processing unit 102 determines execution of CoMP on the basis of, for example, the communication quality of the radio terminal device 3 (Step S1).

The data management unit 121 receives transmission data from the core network 4 (Step S2). Then, the data management unit 121 holds the received transmission data (Step S3).

Furthermore, the data management unit 121 sends the transmission data to the data management unit 221 (Step S4). The data management unit 221 receives the transmission data and holds the transmission data (Step S5).

Then, the data management unit 221 calculates an amount of data of the transmission data (Step S6). Then, the data management unit 221 notifies the RB allocation determination unit 123 of the calculated amount of data (Step S7). The RB allocation determination unit 123 notifies the CA allocation determination unit 124 of the amount of data of the transmission data together with a request to allocate the data (Step S8).

The CA allocation determination unit 124 receives a notification of the amount of data of the transmission data from the RB allocation determination unit 123 together with the request to allocate the data. Then, the CA allocation determination unit 124 determines the allocation of the data in CA on the basis of the amount of data of the transmission data and the use state of the radio resources with the first frequency and the second frequency (Step S9). Then, the CA allocation determination unit 124 notifies the RB allocation determination unit 123 of the allocation result of the data in CA (Step S10).

The RB allocation determination unit 123 receives a notification of the allocation result of the data in CA from the CA allocation determination unit 124. Then, the RB allocation determination unit 123 determines, by using the allocation result of the data in CA, the resource blocks used in the first frequency and the second frequency (Step S11).

Then, the RB allocation determination unit 123 notifies the RB allocation determination unit 223 of the allocation result of the data performed by using CA (Step S12). Furthermore, the RB allocation determination unit 123 notifies the RB allocation determination unit 223 of the allocation result of the resource blocks (Step S13).

The RB allocation determination unit 123 notifies the data processing unit 122 of the allocation result of the resource blocks (Step S14). Furthermore, the RB allocation determination unit 123 notifies the data management unit 121 of the amount of data to which the resource blocks have been allocated (Step S15). Furthermore, the processes performed at Steps S12 to S15 are not limited to the order illustrated in FIG. 5 and the order of the processes performed may also be appropriately changed.

The data management unit 121 receives, from the RB allocation determination unit 123, a notification of the amount of the pieces of the data to which the resource blocks have already been allocated. Then, the data management unit 121 acquires, from the transmission data, data with the amount of data to which the resource blocks have already been allocated and then outputs the acquired data to the data processing unit 122 (Step S16).

The data processing unit 122 receives a notification of the allocation result of the resource blocks from the RB allocation determination unit 123. Furthermore, the data processing unit 122 receives, from the data management unit 121, an input of the data with the amount of data that has already been allocated to the resource blocks. Then, the data processing unit 122 sends, to the radio terminal device 3, the acquired data by using the allocated resource blocks that are used in the first frequency and the second frequency (Step S17).

In contrast, the RB allocation determination unit 223 receives, from the RB allocation determination unit 123, a notification of the allocation result of the data in CA and the allocation result of the resource blocks. Then, the RB allocation determination unit 223 notifies the data management unit 221 of the allocation result of the data in CA (Step S18). The data management unit 221 receives the notification of the allocation result of the data in CA from the RB allocation determination unit 223. Then, the data management unit 221 selects, in accordance with the allocation result of the data in CA, the data to be sent with the first frequency included in the transmission data (Step S19).

The RB allocation determination unit 223 notifies the data processing unit 222 of the allocation result of the resource blocks (Step S20). Furthermore, the RB allocation determination unit 223 notifies the data management unit 221 of the amount of the pieces of the data to which the respective resource blocks have already been allocated (Step S21).

The data management unit 221 receives the notification of the amount of the pieces of the data to which the respective resource blocks have already been allocated from the RB allocation determination unit 223. Then, the data management unit 221 acquires the data with the amount of the pieces of the data to which the respective resource blocks have already been allocated from among the selected pieces of data to be sent with the first frequency and then outputs the acquired data to the data processing unit 222 (Step S22).

The data processing unit 222 receives the notification of the allocation result of the resource blocks from the RB allocation determination unit 223. Furthermore, the data processing unit 222 receives, from the data management unit 221, an input of the data to be sent. Then, the data processing unit 222 sends the acquired data to the radio terminal device 3 by using the specified resource blocks (Step S23).

As described above, when the coordination source base station according to the embodiment uses CoMP by performing CA, the coordination source base station notifies the coordination destination base station of the allocation result of the data to be allocated to each carrier in CA. Then, in response to the notification of the allocation result of the data with respect to each of the frequencies used in CA, the coordination destination base station selects the data that has been allocated to the carrier used in CoMP from the transmission destination data and sends the data to the radio terminal device by using the specified radio resource. Consequently, it is possible to avoid inconsistency in the data between the coordination source base station and the coordination destination base station and thus appropriately perform communication using CoMP by performing CA.

Furthermore, the radio communication system according to the embodiment allows the coordination destination base station to previously hold all of the pieces of the transmission data; notifies of information for identifying the data that is to be sent from the base station serving as the coordination destination for CoMP; and allows the coordination destination base station to select transmission data. Consequently, it is possible to reduce the time taken from allocation determination of the resource blocks to data transmission.

Furthermore, in the description above, in order to use the existing communication path, the RB allocation determination unit 123 notifies the RB allocation determination unit 223 of the allocation result of the resource blocks or the data allocation result in CA. However, by newly adding a communication path, the RB allocation determination unit 123 may also directly notify the data management unit 221 or the data processing unit 222 without passing through the RB allocation determination unit 223. Furthermore, it may also possible to use the configuration in which the CA allocation determination unit 124 directly notifies the data management unit 221 of data allocation result in CA.

### Second Embodiment

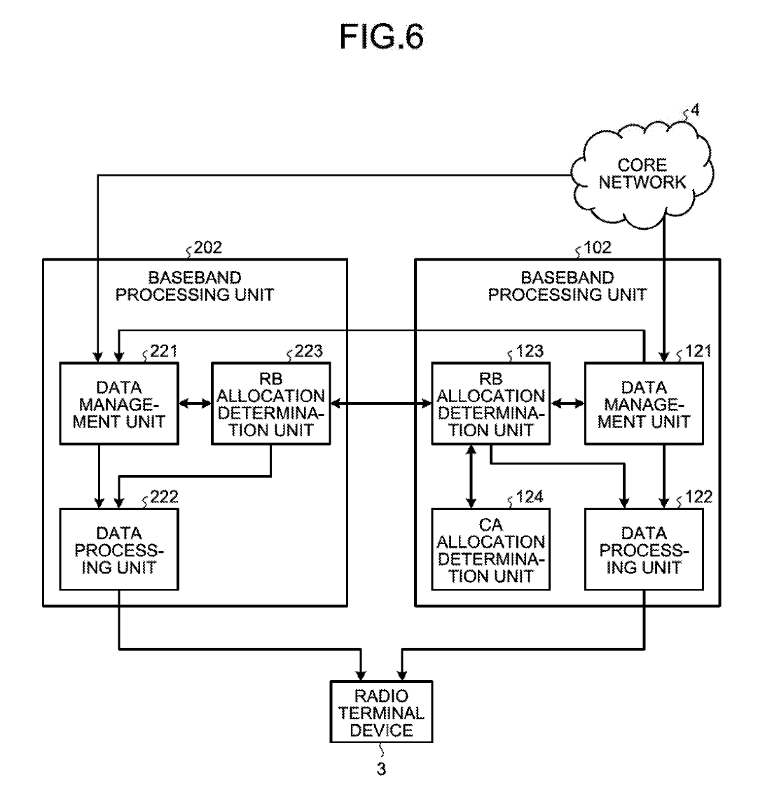

FIG. 6 is a block diagram illustrating a baseband processing unit according to a second embodiment. A radio communication device according to the second embodiment differs from the first embodiment in that allocation of resources in CA is performed by using the use state of the radio resource used in the frequency that is used for CoMP by the coordination destination base station. In the following, a description will mainly be given of a method of determining allocation of the resources in CA performed by using the use state of the radio resource used in a frequency that is used by the coordination destination base station for CoMP. In a description below, regarding each of the units included in the baseband processing units 102 and 202, descriptions of the same function as that described in the first embodiment will be omitted.

The data management unit 221 receives the data to be transmitted to a radio terminal device (not illustrated) accommodated in the base station device 2 from the core network 4. Then, the data management unit 221 sends an allocation request for resource blocks to the RB allocation determination unit 223. Then, the data management unit 221 receives a notification of the amount of data that has been allocated to the resource blocks from the RB allocation determination unit 223. Then, the data management unit 221 acquires, from the data to be sent to the radio terminal device accommodated in the base station device 2, the data by the amount corresponding to the data allocated to the resource blocks and then outputs the acquired data to the data processing unit 222.

The RB allocation determination unit 223 receives an allocation request for the resources from the data management unit 221. Then, the RB allocation determination unit 223 allocates the resource blocks to the data received by the data management unit 221. Then, the RB allocation determination unit 223 notifies the data processing unit 222 of the allocation result of the resource blocks. Furthermore, the RB allocation determination unit 223 notifies the data management unit 221 of the amount of the pieces of data that have been allocated to the resource blocks.

Furthermore, when the resource blocks used in the first frequency is used for the data to be sent to the radio terminal device accommodated in the base station device 2, the RB allocation determination unit 223 checks the availability of the resource blocks used in the first frequency. Then, the RB allocation determination unit 223 sends the information on the availability of the resource blocks used in the first frequency, i.e. the unused resource blocks used in the first frequency to the RB allocation determination unit 123. At this point, if the use state of the resource blocks used in the first frequency has been changed, even in another case, the RB allocation determination unit 223 sends a notification indicating the availability of the resource blocks used in the first frequency. For example, even if CoMP is performed with another base station device and the resource blocks used in the first frequency is used, the RB allocation determination unit 223 sends a notification indicating the availability of the resource blocks used in the first frequency. Here, the RB allocation determination unit 223 only needs to notify the RB allocation determination unit 123 of a margin of the resource blocks used in the first frequency, i.e., the information that is used to recognize an amount of resource blocks that can be allocated. Consequently, regarding the information on the availability of the resource blocks used in the first frequency notified by the RB allocation determination unit 223, the information on the number of or the rate of resource blocks that can be allocated can be used. Furthermore, regarding the information on the availability of the resource blocks, for example, the information, such as the position of the resource blocks that can be allocated, the identification information, or the like, that is used to specify the resource blocks that can be allocated is included. The RB allocation determination unit 223 corresponds to an example of a “notifying unit”.

Here, in the embodiment, the RB allocation determination unit 223 sends a notification indicating the availability by using the information on the availability of the resource blocks; however, another information may also be used for the information to be used as long as information from which the use state of the resource blocks can be identified. For example, the RB allocation determination unit 223 may also send a notification indicating the availability by using the information that indicates the occupied state of the resource blocks. In this case, the information indicating the occupied state of the resource blocks includes, for example, information that is used to, in addition to specify the number of or the rate of the allocated resource blocks, to specify the allocated resource blocks, such as the position or the identification information on the resource blocks that have been allocated.

The data processing unit 222 receives, from the data management unit 221, an input of data that is to be sent to the radio terminal device that is accommodated in the base station device 2. Furthermore, the data processing unit 222 receives a notification of the allocation result of the resource blocks from the RB allocation determination unit 223. Then, the data processing unit 222 sends, by using the notified resource blocks, the data to the radio terminal device accommodated in the base station device 2.

The RB allocation determination unit 123 receives, from the RB allocation determination unit 223, the information on the resource blocks used in the first frequency that are not used by the baseband processing unit 202. At this time, if the RB allocation determination unit 123 has acquired the allocation result of the data in CA from the CA allocation determination unit 124, the RB allocation determination unit 123 retains the notification of the allocation result of the data in CA with respect to the RB allocation determination unit 223.

Then, the RB allocation determination unit 123 notifies the CA allocation determination unit 124 of the information on the resource block used in the first frequency that is not used by the baseband processing unit 202. Then, the RB allocation determination unit 123 receives, from the CA allocation determination unit 124, a notification of the allocation result of the data in CA by taking into consideration the availability of the resource blocks used in the first frequency in the baseband processing unit 202. Then, the RB allocation determination unit 123 allocates the resource blocks by using the allocation information on the data in CA acquired from the CA allocation determination unit 124. Furthermore, the RB allocation determination unit 123 sends, to the RB allocation determination unit 223, allocation result of the data in CA acquired from the CA allocation determination unit 124 and the allocation result of the resource blocks.

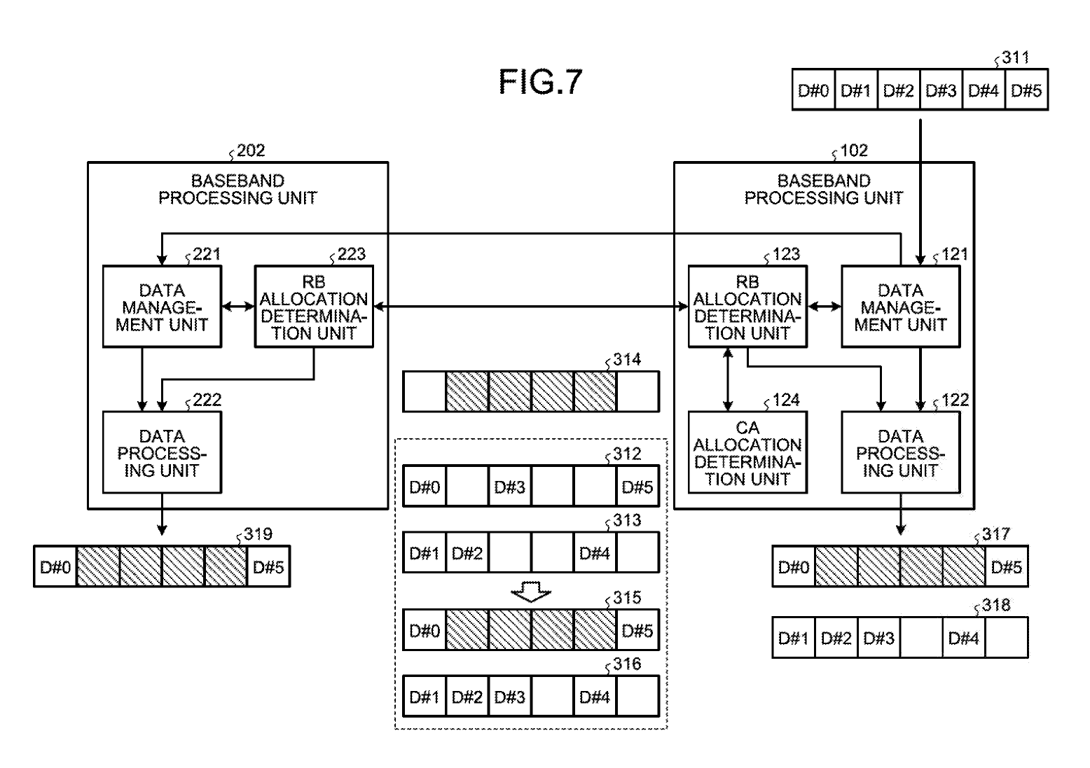

In the following, selecting data when CA and CoMP are performed in the radio communication system according to the embodiment will be described with reference to FIG. 7. FIG. 7 is a schematic diagram illustrating selecting data when CA and CoMP are performed in the radio communication system according to the second embodiment. Here, a description will be given of a case in which the transmission data including the pieces of the data #0 to #5 are sent from the core network 4 to the base station device 1. Furthermore, here, a description will be given of a case in which, after allocation of the data in CA has been determined in a state in which no resource block used in the first frequency is used in the base station device 2, the availability of the resource blocks used in the first frequency in the base station device 2 is notified.

The data management unit 121 in the baseband processing unit 102 receives transmission data 311 that includes therein the pieces of the data #0 to #5 from the core network 4. At this point, because a notification of the availability of the resource blocks used in the first frequency in the base station device 2 has not been received, the CA allocation determination unit 124 allocates the pieces of the data #0, #3, and #5 included in the transmission data 311 as the data to be sent with the first frequency. Furthermore, the CA allocation determination unit 124 allocates the pieces of the data #1, #2, and #4 included in the transmission data 311 as the data to be sent with the second frequency.

Then, the RB allocation determination unit 123 receives a notification of the allocation result of the data in CA from the CA allocation determination unit 124. Then, the RB allocation determination unit 123 allocates the resource blocks to the pieces of the data #0, #3, and #5 as indicated by a resource allocation state 312. For example, it is assumed that each of the resource blocks in the resource allocation state 312 illustrated in FIG. 7 are sequentially represented by RBs #0 to #6. In this case, in the resource allocation state 312 illustrated in FIG. 7, the data #0 (D #0) is allocated to the first resource block (RB #1). Furthermore, the data #3 (D #3) is allocated to the third resource block (RB #3). Furthermore, the data #5 (D #5) is allocated to the sixth resource block (D #6).

Furthermore, the RB allocation determination unit 123 allocates the resource blocks to the pieces of the data #1, #2, and #4 as indicated by a resource allocation state 313. For example, it is assumed that the resource blocks in the resource allocation state 313 illustrated in FIG. 7 are sequentially represented by RBs #0 to #6. In this case, in the resource allocation state 313 illustrated in FIG. 7, the data #1 (D #1) is allocated to the first resource block (RB #1). Furthermore, the data #2 (D #2) is allocated to a second resource block (RB #2). Furthermore, the data #4 (D #4) is allocated to a fifth resource block (D #6).

However, at this point, the RB allocation determination unit 123 receives resource block information 314 indicating the availability of the resource blocks used in the first frequency from the RB allocation determination unit 223. The resource block information 314 includes therein the information, for example, that specify the resource block that can be allocated. The RB allocation determination unit 123 specifies the resource blocks obtained by excluding the allocatable resource blocks from the information that specify the resource blocks that can be allocated and that are included in the resource block information 314 and sets the specified resource blocks to the resource blocks that have already been used. Here, the resource blocks indicated by using the oblique lines in the resource block information 314 represents the resource blocks that have already been used. Thus, the RB allocation determination unit 123 suspends the information indicating that the pieces of the data #0, #3, and #5 have been allocated as the data to be sent with the first frequency from being sent to the RB allocation determination unit 223 in the baseband processing unit 202.

Here, in the second embodiment, the RB allocation determination unit 123 specifies the used resource blocks by using the information that indicates the availability; however, the used resource blocks can similarly be specified by another piece of information that indicates the use state of the resource blocks. For example, the used resource blocks can also be specified even when the RB allocation determination unit 123 receives the information that indicates the occupied state of the resource blocks from the RB allocation determination unit 223. In this case, the RB allocation determination unit 123 acquires, from the information that indicates the occupied state of the resource blocks, the information that specifies the allocated resource blocks. Then, the RB allocation determination unit 123 sets the resource blocks specified by the information that specifies the acquired allocated resource blocks to the used resource blocks.

Then, the RB allocation determination unit 123 notifies the CA allocation determination unit 124 of the resource block information 314. The CA allocation determination unit 124 acquires the resource block information 314 from the RB allocation determination unit 123. Then, the CA allocation determination unit 124 corrects the allocation of the data to the first frequency and the second frequency so as not to use the resource blocks that are specified as the used resource blocks by the resource block information 314. Then, the CA allocation determination unit 124 notifies the RB allocation determination unit 123 of the allocation result of the corrected data in CA.

The RB allocation determination unit 123 acquires the allocation result of the corrected data in CA from the RB allocation determination unit 223. Then, the RB allocation determination unit 123 again allocates the resource blocks by using the allocation information on the corrected data in CA. Here, the resource block used for the data #3 is the allocated resource block. Thus, because the resource block used for the data #3 is not able to be allocated to data, the RB allocation determination unit 123 determines that the resource block used for the data #3 is a restricted resource block. Then, because the use of the resource block that has been used for the data #3 with the first frequency restricted, the RB allocation determination unit 123 allocates the data #3 to the resource block used in the second frequency. Consequently, the RB allocation determination unit 123 allocates the pieces of the data #0 and #5 to the resource blocks as indicated by a resource allocation state 315. Furthermore, the RB allocation determination unit 123 allocates the pieces of the data #1, #2, #3, and #4 to the resource blocks as indicated by a resource allocation state 316. Namely, the resource allocation states 312 and 313 are changed to the resource allocation states 315 and 316, respectively.

The RB allocation determination unit 123 sends, to the RB allocation determination unit 223 in the baseband processing unit 202, the information indicating that the pieces of the data #0 and #5 are allocated as the data to be sent with the first frequency. Furthermore, the RB allocation determination unit 123 sends the allocation result of the resource blocks, i.e., the information indicating the resource allocation states 315 and 316, to the data processing unit 122. Furthermore, the RB allocation determination unit 123 sends the information indicating the resource allocation state 315 to the RB allocation determination unit 223.

By using the received allocation result of the resource blocks, the data processing unit 122 sends the pieces of the data #0 and #5 to the radio terminal device 3 with the first frequency by using the resource blocks indicated by a resource allocation state 317. Furthermore, the data processing unit 122 sends, by using the received allocation result of the resource blocks, the pieces of the data #1, #2, #3, and #4 to the radio terminal device 3 with the second frequency by using the resource blocks indicated by a resource allocation state 318.

The RB allocation determination unit 223 in the baseband processing unit 202 sends, to the data management unit 221, the information indicating that the pieces of the data #0 and #5 have been allocated as the data to be sent with the first frequency. Furthermore, the RB allocation determination unit 223 outputs the information indicating the resource allocation state 315 to the data processing unit 222.

The data management unit 221 receives the transmission data 311 that includes therein the pieces of the data #0 to #5 from the data management unit 121. Then, the data management unit 221 selects, from the transmission data, the pieces of the data #0 and #5 as the data to be sent, by using the first frequency, as the coordination destination base station of CoMP. Then, the data management unit 221 sends the selected pieces of the data #0 and #5 to the data processing unit 222.

The data processing unit 222 receives an input of the pieces of the data #0 and #5 from the data management unit 221. Furthermore, the data processing unit 222 receives an input of the information indicating the resource allocation state 315 from the RB allocation determination unit 223. Then, the data processing unit 222 sends the pieces of the data #0 and #5 to the radio terminal device 3 by using the same resource blocks as those indicated by the resource allocation state 315. Namely, the data processing unit 222 sends the pieces of the data #0 and #5 to the radio terminal device 3 by using the resource blocks indicated by a resource allocation state 319.

By performing the processes described above, the data sent by the base station device 1 with the first frequency and the data sent by the base station device 2 with the first frequency are, as indicated by the resource allocation states 317 and 319, the same data and are sent by using the same resource blocks.

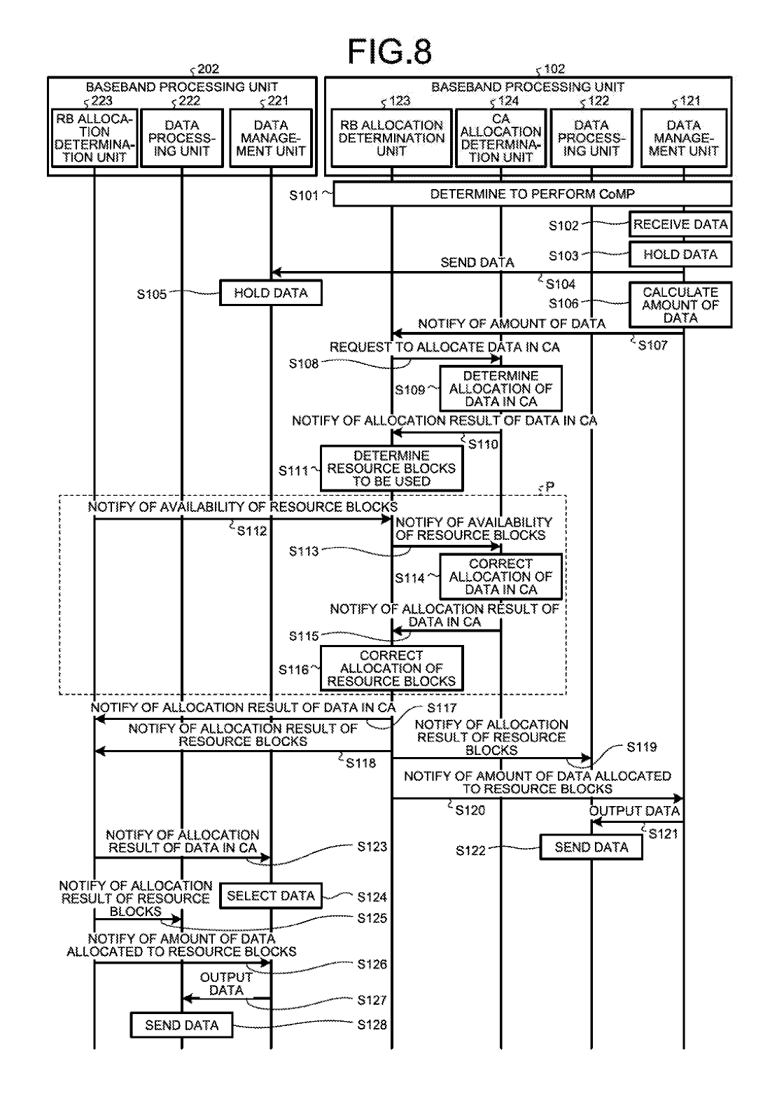

In the following, the flow of communication control performed in the radio communication system according to the embodiment by using the CA and the CoMP will be described with reference to FIG. 8. FIG. 8 is a sequence diagram illustrating communication control performed in a radio communication system according to the second embodiment by using the CA and the CoMP.

The baseband processing unit 102 determines to perform CoMP on the basis of, for example, the communication quality of the radio terminal device 3 (Step S101).

The data management unit 121 receives transmission data from the core network 4 (Step S102). Then, the data management unit 121 holds the received transmission data (Step S103).

Furthermore, the data management unit 121 sends the transmission data to the data management unit 221 (Step S104). The data management unit 221 receives the transmission data and holds the transmission data (Step S105).

Then, the data management unit 121 calculates an amount of data of the transmission data (Step S106). Then, the data management unit 121 notifies the RB allocation determination unit 123 of the calculated amount of data (Step S107). The RB allocation determination unit 123 notifies the CA allocation determination unit 124 of the amount of data of the transmission data together with the allocation request of the data (Step S108).

The CA allocation determination unit 124 receives the notification of the amount of data of the transmission data together with the allocation request for the data from the RB allocation determination unit 123. Then, the CA allocation determination unit 124 determines the allocation of data in CA on the basis of the amount of data of the transmission data and on the basis of the use state of the radio resources used in the first frequency and the second frequency (Step S109). Then, the CA allocation determination unit 124 notifies the RB allocation determination unit 123 of the allocation result of the data in CA, i.e., the allocation result of the data in CA (Step S110).

The RB allocation determination unit 123 receives the notification of the allocation result of the data in CA from the CA allocation determination unit 124. Then, the RB allocation determination unit 123 determines, by using the allocation result of the data in CA, the resource blocks to be used with the first frequency and the second frequency (Step S111).

Here, the RB allocation determination unit 223 checks that a change in the availability of the resource blocks to be used in the first frequency has occurred and notifies the RB allocation determination unit 123 of the availability of the resource blocks (Step S112). The RB allocation determination unit 123 receives the notification of the availability of the resource blocks from the RB allocation determination unit 223. Then, the RB allocation determination unit 123 notifies the CA allocation determination unit 124 of the availability of the resource blocks (Step S113).

The CA allocation determination unit 124 receives the notification of the availability of the resource blocks from the RB allocation determination unit 123. Then, the CA allocation determination unit 124 again allocates the data in CA by using the resource blocks that are not used by the baseband processing unit 202 from among the resource blocks used in the first frequency and corrects the allocation of the data in CA (Step S114). Then, the CA allocation determination unit 124 notifies the RB allocation determination unit 123 of the allocation result of the corrected data in CA (Step S115).

The RB allocation determination unit 123 receives the notification of the allocation result of the corrected data in CA from the CA allocation determination unit 124. Then, the RB allocation determination unit 123 again determines, by using the allocation result of the corrected data in CA, the resource blocks that are used in the first frequency and the second frequency and correct the allocation of the resource blocks (Step S116).

Then, the RB allocation determination unit 123 notifies the RB allocation determination unit 223 of the allocation result of the data in CA (Step S117). Furthermore, the RB allocation determination unit 123 notifies the RB allocation determination unit 223 of the allocation result of the resource blocks (Step S118).

Then, the RB allocation determination unit 123 notifies the data processing unit 122 of the allocation result of the resource blocks (Step S119). Furthermore, the RB allocation determination unit 123 notifies the data management unit 121 of an amount of the pieces of the data that have already been allocated in the resource blocks (Step S120).

The data management unit 121 receives the notification of the amount of the pieces of the data that have already been allocated in the resource blocks from the RB allocation determination unit 123. Then, the data management unit 121 acquires the amount of the pieces of the data that have already been allocated in the resource blocks from the transmission data and output the data to the data processing unit 122 (Step S121).

The data processing unit 122 receives the notification of the allocation result of the resource blocks from the RB allocation determination unit 123. Furthermore, the data processing unit 122 receives an input of the data with the amount of data allocated to the resource blocks from the data management unit 121. Then, the data processing unit 122 sends the acquired data to the radio terminal device 3 by using the allocated resource blocks used in the first frequency and the second frequency (Step S122).

In contrast, the RB allocation determination unit 223 receives the notification of the allocation result of the data in CA and the allocation result of the resource blocks from the RB allocation determination unit 123. Then, the RB allocation determination unit 223 notifies the data management unit 221 of the allocation result of the data in CA (Step S123). The data management unit 221 receives the notification of the allocation result of the data in CA from the RB allocation determination unit 223. Then, the data management unit 221 selects, from the transmission data in accordance with the allocation result of the data in CA, the data to be sent with the first frequency (Step S124).

The RB allocation determination unit 223 notifies the data processing unit 222 of the allocation result of the resource blocks (Step S125). Furthermore, the RB allocation determination unit 223 notifies the data management unit 221 of the amount of the pieces of the data that have already been allocated to the resource blocks (Step S126).

The data management unit 221 receives the notification of the amount of the data allocated to the resource blocks from the RB allocation determination unit 223. Then, the data management unit 221 acquires, from the selected data to be sent with the first frequency, the amount of the data allocated to the resource blocks and output the data to the data processing unit 222 (Step S127).

The data processing unit 222 receives the notification of the allocation result of the resource blocks from the RB allocation determination unit 223. Furthermore, the data processing unit 222 receives, from the data management unit 221, an input of the data to be transmitted. Then, the data processing unit 222 sends the acquired data to the radio terminal device 3 by using the specified resource blocks (Step S128).

Here, in the embodiment, a description has been given of a case in which, after allocation of data in CA has been performed once, the availability of the resource blocks used in the first frequency is changed in the base station device 2; however, a change in the availability of the resource blocks may also possibly occur at another timing. For example, if a change in the availability of the resource blocks occurs before allocation of data in CA is performed, when the allocation of the data in CA is performed first time, the availability of the resource blocks is considered and no correction is performed after that. Furthermore, after the allocation of the data in CA is corrected due to a change in the availability of the resource blocks, the availability of the resource blocks may also possibly be changed. In this case, the allocation of the data in CA is corrected again in accordance with the availability of the notified resource blocks. In this way, if the timing of a change in the availability of the resource blocks is changed, the processes enclosed by a frame P are performed in another timing.

As described above, the radio communication system according to the embodiment notifies the coordination source base station of the availability of the resource blocks in the coordination destination base station with the frequency used in the CoMP and determines the allocation of the data in CA by using the available resource blocks. Consequently, it is possible to appropriately combining CA and CoMP by considering the state of the radio resources of the coordination destination base station used for CoMP and optimize the allocation of data to each of the frequencies used in CA.

Hardware Configuration

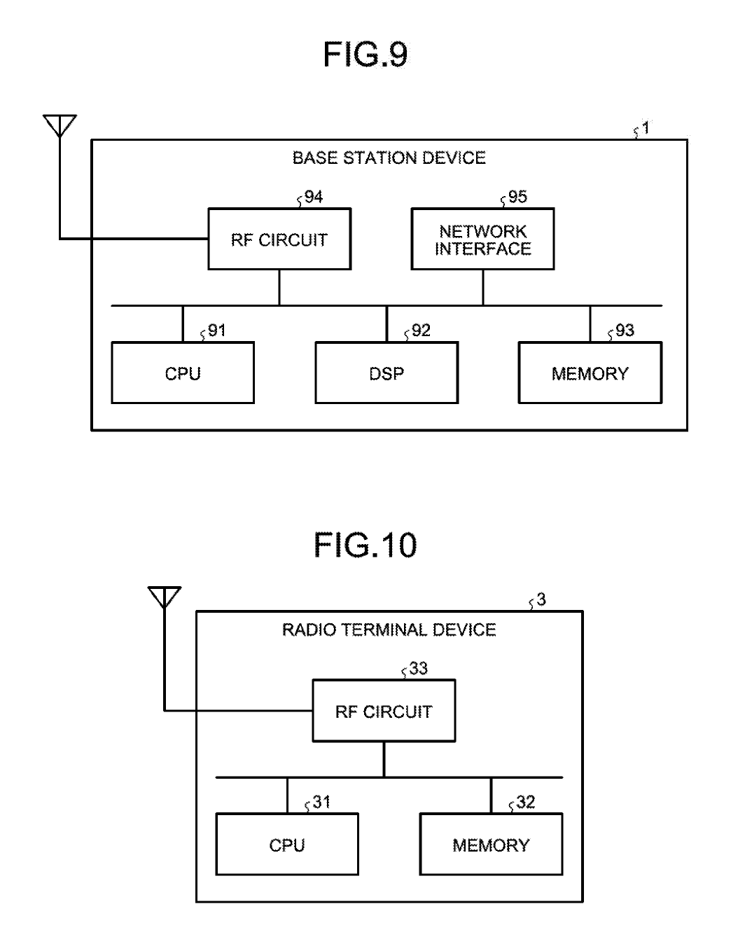

In the following, the hardware configuration of the base station device 1 according to each of the embodiments will be described with reference to FIG. 9. FIG. 9 is a block diagram illustrating the hardware configuration of the base station device. Here, the base station device 1 will be described as an example; however, the base station device 2 has the same hardware configuration.

The base station device 1 includes a central processing unit (CPU) 91, a digital signal processor (DSP) 92, a memory 93, a radio frequency (RF) circuit 94, and a network interface 95. The CPU 91 and the DSP 92 are connected to the memory 93, the RF circuit 94, and the network interface 95 by a bus. Furthermore, the CPU 91 and the DSP 92 are connected with each other and can communicate with each other.

The RF circuit 94 is connected to an antenna. The RF circuit 94 is a circuit that sends and receives a radio signal and implements the function of the radio communication unit 101 exemplified in FIG. 2.

The network interface 95 is connected to a core network. The network interface 95 implements the function of the network communication unit 103 exemplified in FIG. 2.

The CPU 91 mainly performs the overall control of each of the units in the base station device 1 and performs the setting of the parameters. The DSP 92 mainly controls the radio communication process. The DSP 92 implements the function of the baseband processing unit 102 exemplified in FIG. 2.

For example, the memory 93 stores therein various kinds of programs including the program that implements the function of the baseband processing unit 102 that includes therein the data management unit 121, the data processing unit 122, the RB allocation determination unit 123, and the CA allocation determination unit 124 exemplified in FIG. 3. The DSP 92 implements the function of the baseband processing unit 102 that included therein the data management unit 121, the data processing unit 122, the RB allocation determination unit 123, and the CA allocation determination unit 124 by reading and executing various kinds of programs from the memory 93. Here, in the embodiment, a description has been given of a case in which the DSP 92 implements the function of the baseband processing unit 102; however, the function of the baseband processing unit 102 may also be implemented by the CPU 91.

Furthermore, the DSP 92 and the memory 93 in the base station device 2 implements the function of the data management unit 221, the data processing unit 222 and the RB allocation determination unit 223 exemplified in FIG. 3.

In the following, the hardware configuration of the radio terminal device 3 will be described with reference to FIG. 10. FIG. 10 is a block diagram illustrating the hardware configuration of a radio terminal device. As illustrated in FIG. 10, the radio terminal device 3 includes a CPU 31, a memory 32, and an RF circuit 33.

The RF circuit 33 is connected to an antenna. Then, the RF circuit 33 receives the radio signals sent from the base station devices 1 and 2 and sends the radio signals to the base station device 1.

The CPU 31 performs a baseband process on the signals received by the RF circuit 33. Furthermore, the CPU 31 converts the signal that has been subjected to the baseband process to a radio signal and outputs the converted signal to the RF circuit 33.

According to an aspect of an embodiment of the radio communication system, the base station device, and the radio communication method disclosed in the present invention, an advantage is provided in that CA and CoMP are simultaneously and appropriately performed.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A radio communication system comprising:
a first base station device;
a second base station device; and
a radio terminal device, wherein
the first base station device includes
a data management unit that receives transmission data to be sent to the radio terminal device,
an allocation determination unit that determines allocation of each of first data to be sent by using a first frequency band and second data to be sent by using a second frequency band that are included in the transmission data and that notifies the second base station device of information on the first data,
a resource allocation unit that allocates a radio resource to each of the first data and the second data determined by the allocation determination unit and that notifies the second base station device of information on the radio resource allocated to the first data, and
a first sending unit that sends, by using the radio resources allocated by the resource allocation unit, the first data and the second data to the radio terminal device, and
the second base station device includes
a receiving unit that receives, in coordination with the first base station device, transmission data that includes therein the first data to be sent to the radio terminal device,
a data selecting unit that acquires the information on the first data notified by the allocation determination unit and that selects the first data from the transmission data based on the information on the first data, and
a second sending unit that acquires the information that is related to the radio resource allocated to the first data and that is notified by the resource allocation unit and that sends the first data selected by the data selecting unit to the radio terminal device by using the radio resource allocated to the first data.

2. The radio communication system according to claim 1, wherein
the second base station device further includes a notifying unit that notifies the allocation determination unit of the radio resource used in the first frequency band by the second base station device to perform another data transmission, and
the allocation determination unit determines allocation of each of the first data and the second data, based on information obtained by excluding the radio resource notified by the notifying unit from the radio resource used in the first frequency band.

3. A base station device that performs communication, in coordination with another base station device, with respect to a radio terminal device by using a first frequency band, the base station device comprising:
a data management unit that receives transmission data to be sent to the radio terminal device;
an allocation determination unit that determines allocation of each of first data to be sent by using the first frequency band and second data to be sent by using a second frequency band that are included in the transmission data and that notifies the other base station device of information on the first data;
a resource allocation unit that allocates a radio resource to each of the first data and the second data determined by the allocation determination unit, that notifies the other base station device of information on the radio resource allocated to the first data, and that allows the other base station device to send the first data to the radio terminal device by using the radio resource allocated to the first data; and
a sending unit that sends, by using the radio resources allocated by the resource allocation unit, the first data and the second data to the radio terminal device.

4. A radio communication method of performing, by a first base station device and a second base station device in coordination with each other, communication with respect to a radio terminal device by using a first frequency band, the radio communication method comprising:
receiving, performed by the first base station device and the second base station device, transmission data;
determining, performed by the first base station device, allocation of each of first data to be sent by using the first frequency band and second data to be sent by using a second frequency band that are included in the transmission data and notifying, performed by the first base station device, the second base station device of information on the first data;
receiving, performed by the second base station device, the information on the first data sent by the first base station device and selecting, performed by the second base station device, the first data from the transmission data based on the information on the first data;
allocating, performed by the first base station device, a radio resource to each of the first data and the second data and notifying, performed by the first base station device, the second base station device of information on the radio resource allocated to the first data;
sending, performed by the first base station device, by using the radio resources allocated to the first frequency band and the second frequency band, the first data and the second data to radio terminal device; and
receiving, performed by the second base station device, the information on the radio resource allocated to the first data sent by the first base station device and sending, performed by the second base station device, the first data to the radio terminal device by using the radio resource allocated to the first data.
